(19) United States
(12) Patent Application Publication
(10) Pub. No.: US 2011/0241762 A1
(43) Pub. Date: Oct. 6, 2011

(54) FUSE CIRCUIT

(75) Inventor: Keun Kook KIM, Seoul (KR)

(73) Assignee: HYNIX SEMICONDUCTOR INC., Gyeonggi-do (KR)

(21) Appl. No.: 13/013,906

(22) Filed: Jan. 26, 2011

(30) Foreign Application Priority Data
Mar. 31, 2010 (KR) 10-2010-0029516

(51) Int. Cl. H01H 37/76

(52) U.S. Cl. 327/525

(57) ABSTRACT

A fuse circuit includes a fuse, a control pulse generation unit, and an equipotential element. The fuse is coupled between a power supply voltage terminal and a first node. The control pulse generation unit is configured to generate a control pulse including a pulse generated in a period in which a power-up period is ended. The equipotential element is configured to make the first node have the same potential as a power supply voltage in response to the control pulse.

### CROSS-REFERENCES TO RELATED APPLICATIONS

The present application claims priority under 35 U.S.C 119(a) to Korean Application No. 10-2010-0029516, filed on Mar. 31, 2010, in the Korean intellectual property Office, which is incorporated herein by reference in its entirety as set forth in full.

### BACKGROUND

Semiconductor integrated circuit products employ an option processing in order for mode switching. Examples of the existing option processing include a bonding option, a metal option, and a fuse option.

In particular, the fuse option is widely used in a case where an abnormal memory cell occurring during a fabrication process of a semiconductor memory device is replaced with a normal memory cell and a case where a design of a semiconductor memory chip is modified. The fuse option is implemented in such a manner that a fuse is cut by irradiating laser beams or flowing an excessive current. A circuit including at least one fuse for the fuse option is referred to as a fuse circuit.

FIG. 1 is a circuit diagram illustrating a configuration of a conventional fuse circuit.

As illustrated in FIG. 1, the conventional fuse circuit includes a fuse F10, an NMOS transistor N10, and an inverter IV10. The fuse F10 is coupled between a power supply voltage (VDD) terminal and a node nd10. The NMOS transistor N10 is coupled between the node nd10 and a ground voltage (VSS) terminal and configured to be turned on in response to a power-up signal PWRUP and pull-down drive the node nd10. The inverter IV10 operates as a buffer which buffers a signal of the node nd10 and outputs a latch output signal OUT. The power-up signal PWRUP is a signal which is enabled to a logic high level during a power-up period and changes to a logic low level after the end of the power-up period.

The fuse circuit having the above-described configuration determines the level of the latch output signal OUT according to the cutting of the fuse F10. For example, when the fuse F10 is not cut, the latch output signal OUT is outputted at a logic high level. When the fuse F10 is cut, the latch output signal OUT is outputted at a logic low level.

However, in a case where the fuse F10 is formed of a material such as copper (Cu), the fuse F10 having been cut is again coupled by a potential difference between both terminals of the fuse F10, causing an error that the latch output signal OUT is outputted at a logic high level. This is because copper ions are moved to fill the cut portion when a potential difference occurs between both terminals of the fuse F10.

### SUMMARY

An embodiment of the presently claimed invention provides a fuse circuit in which a potential difference does not occur between both terminals of a cut fuse, thereby substantially preventing an occurrence of error.

In one embodiment, a fuse circuit includes: a fuse coupled between a power supply voltage terminal and a first node; a control pulse generation unit configured to generate a control pulse including a pulse generated in a period in which a power-up period is ended; and an equipotential element configured to make the first node have the same potential as a power supply voltage in response to the control pulse.

In another embodiment, a fuse circuit includes: a fuse coupled between a power supply voltage terminal and a first node; a control pulse generation unit configured to generate a control pulse including a pulse generated in a period in which a power-up period is ended; an equipotential element configured to make the first node have the same potential as a power supply voltage in response to a control pulse; a switch element coupled between the first node and a second node and configured to be turned on in response to the control pulse; a first pull-down element coupled between the second node and a ground voltage terminal and configured to pull-down drive the second node in response to a power-up signal; a latch unit configured to latch a signal of the second node; and a buffer unit configured to buffer an output signal of the latch unit and generate a latch output signal.

### BRIEF DESCRIPTION OF THE DRAWINGS

The above and other aspects, features and other advantages will be more clearly understood from the following detailed description taken in conjunction with the accompanying drawings, in which:

FIG. 1 is a circuit diagram illustrating a configuration of a conventional fuse circuit;

FIG. 2 is a schematic diagram illustrating a configuration of a fuse circuit according to an embodiment of the present invention; and

FIG. 3 is a circuit diagram of a control pulse generation unit included in the fuse circuit of FIG. 2.

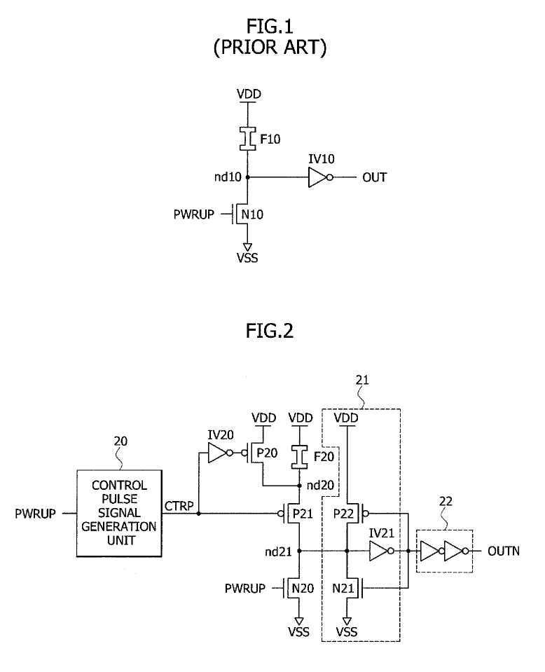

### DESCRIPTION OF SPECIFIC EMBODIMENTS

Hereinafter, various exemplary embodiments will now be described more fully with reference to the accompanying drawings in which some exemplary embodiments are shown. However, specific structural and functional details disclosed herein are merely representative for purposes of describing exemplary embodiments of the present invention and are not intended to limit the scope of the invention. Like numbers refer to like elements throughout the description of the drawings.

The terminology used herein is for the purpose of describing particular embodiments only and is not intended to be limiting of exemplary embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Further, it will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the invention.

FIG. 2 is a schematic diagram illustrating a configuration of a fuse circuit according to an embodiment of the present invention.

As illustrated in FIG. 2, the fuse circuit according to the embodiment of the present invention includes a control pulse generation unit 20, an inverter IV20, a PMOS transistor P20, a fuse F20, a PMOS transistor P21, an NMOS transistor N20, a latch unit 21, and a buffer unit 22, for example. Specifically, the control pulse generation unit 20 is configured to receive a power-up signal PWRUP and generate a control pulse CTRP including a logic low level pulse generated in a period in which a power-up period is ended. The inverter IV20 is configured to invert the control pulse CTRP. The PMOS transistor P20 operates as an equipotential element which makes a node nd20 have the same potential as a power supply voltage VDD in response to an output signal of the inverter IV20. The fuse F20 is coupled between a power supply voltage (VDD) terminal and the node nd20. The PMOS transistor P21 is coupled between the node nd20 and a node nd21 and configured to operate as a switch element which is turned on in response to the control pulse CTRP. The NMOS transistor N20 is coupled between the node nd21 and a ground voltage (VSS) terminal and configured to operate as a pull-down element which pull-down drives the node nd21 in response to the power-up signal PWRUP. The latch unit 21 is configured to latch a signal of the node nd21. The buffer unit 22 is configured to buffer an output signal of the latch unit 21 and generate a latch output signal OUTN.

The latch unit 21 includes an inverter IV21, a PMOS transistor P22, and an NMOS transistor N21, for example. Specifically, the inverter IV21 is configured to operate as a buffer which buffers the signal of the node nd21. The PMOS transistor P22 is configured to operate as a pull-up element which pull-up drives the node nd21 in response to an output signal of the inverter IV21. The NMOS transistor N21 is configured to operate as a pull-down element which pull-down drives the node nd21 in response to the output signal of the inverter IV21.

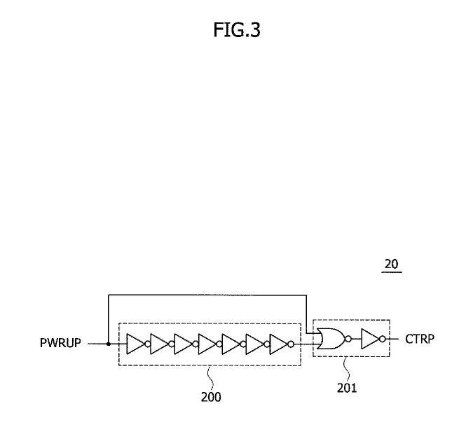

More specifically, referring to FIG. 3, the control pulse generation unit 20 includes an inversion delay section 200 and a logic section 201, for example. The inversion delay section 200 is implemented with a plurality of inverters and configured to invert and delay the power-up signal PWRUP. The logic section 201 is configured to receive the power-up signal PWRUP and an output signal of the inversion delay section 200 and perform an OR operation on the power-up signal PWRUP and the output signal of the inversion delay section 200. The power-up signal PWRUP is a signal which becomes a logic high level while rising along the power supply voltage VDD in a power-up period in which the level of the power supply voltage VDD rises up to a preset level after the power is supplied, and then changes to a logic low level after the power supply voltage VDD rises up to the preset level, that is, the power-up period is ended. The control pulse generation unit 20 configured as above generates the control pulse CTRP including a logic low level pulse having a pulse width corresponding to a delay time of the inversion delay section 200 after the power-up period is ended.

The operation of the fuse circuit configured as above will be described below on the assumption that the fuse F20 is cut.

First, when the power-up signal PWRUP becomes a logic high level in the power-up period, the NMOS transistor N20 is turned on so that the node nd21 is pull-down driven to the ground voltage VSS.

At this time, since the control pulse CTRP generated by the control pulse generation unit 20 is at a logic high level, the PMOS transistor P20 is turned on so that the node nd20 is pull-up driven to the power supply voltage VDD. Therefore, the potentials at both terminals of the cut fuse F20 are equal to each other at the power supply voltage VDD.

When the power-up period is ended, that is, the power-up signal PWRUP changes from a logic high level to a logic low level, the control pulse generation unit 20 generates the control pulse CTRP including the logic low level pulse having the pulse width corresponding to the delay time of the inversion delay section 200. The PMOS transistor P21 is turned on in the period in which the control pulse CTRP of the logic low level is inputted. At this time, since the PMOS transistor P20 is turned off by the control pulse CTRP of the logic low level, the supply of the power supply voltage VDD to the node nd22 is blocked. Thus, the node nd21 is maintained at a logic low level. Therefore, the latch output signal OUTN outputted through the latch unit 21 and the buffer unit 22 becomes a logic high level.

When the input of the logic low level pulse of the control pulse CTRP is completed, the control pulse CTRP changes to a logic high level. The PMOS transistor P20 is turned on by the control pulse CTRP of the logic high level so that the node nd20 is pull-up driven to the power supply voltage VDD. Thus, the potentials at both terminals of the cut fuse F20 are equally maintained at the power supply voltage VDD.

As described above, the fuse circuit according to the embodiment of the present invention constantly maintains the potentials at both terminals of the cut fuse F20 at the power supply voltage VDD in the periods except for the period in which the power-up period is ended and the logic low level pulse of the control pulse CTRP is generated. Therefore, the potential difference does not occur between both terminals of the cut fuse F20, thereby substantially preventing the error that the cut fuse F20 is again coupled and the latch output signal OUTN being outputted at a logic high level.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A fuse circuit comprising:
a fuse coupled between a power supply voltage terminal and a first node;
a control pulse generation unit configured to generate a control pulse including a pulse generated in a period in which a power-up period is ended; and
an equipotential element configured to make the first node have the same potential as a power supply voltage in response to the control pulse.

2. The fuse circuit of claim 1, wherein the control pulse generation unit comprises:
an inversion delay section configured to invert and delay a power-up signal; and
a logic section configured to perform a logic operation on the power-up signal and an output signal of the inversion delay section.

3. The fuse circuit of claim 1, further comprising a switch element coupled between the first node and a second node and configured to be turned on in response to the control pulse.

4. The fuse circuit of claim 3, wherein the switch element comprises a MOS transistor configured to be turned on in a period in which the pulse of the control pulse is not generated.

5. The fuse circuit of claim 1, further comprising a pull-down element coupled between a second node and a ground voltage terminal and configured to pull-down drive the second node in response to a power-up signal.

6. The fuse circuit of claim 1, further comprising:
a latch unit configured to latch a signal of a second node; and
a buffer unit configured to buffer an output signal of the latch unit and generate a latch output signal.

7. The fuse circuit of claim 6, wherein the latch unit comprises:
a buffer configured to buffer the signal of the second node;
a pull-up element configured to pull-up drive the second node in repose to an output signal of the buffer; and
a pull-down element configured to pull-down drive the second node in response to the output signal of the buffer.

8. A fuse circuit comprising:
a fuse coupled between a power supply voltage terminal and a first node;
a control pulse generation unit configured to generate a control pulse including a pulse generated in a period in which a power-up period is ended;
an equipotential element configured to make the first node have the same potential as a power supply voltage in response to the control pulse;
a switch element coupled between the first node and a second node and configured to be turned on in response to the control pulse;
a first pull-down element coupled between the second node and a ground voltage terminal and configured to pull-down drive the second node in response to a power-up signal;
a latch unit configured to latch a signal of the second node; and
a buffer unit configured to buffer an output signal of the latch unit and generate a latch output signal.

9. The fuse circuit of claim 8, wherein the control pulse generation unit comprises:
an inversion delay section configured to invert and delay the power-up signal; and
a logic section configured to perform a logic operation on the power-up signal and an output signal of the inversion delay section.

10. The fuse circuit of claim 9, wherein the latch unit comprises:
a buffer configured to buffer the signal of the second node;
a pull-up element configured to pull-up drive the second node in response to an output signal of the buffer; and
a second pull-down element configured to pull-down drive the second node in response to the output signal of the buffer.
